(19) United States
(12) Patent Application Publication
(10) Pub. No.: US 2025/0058949 A1
(43) Pub. Date: Feb. 20, 2025

(54) PACKAGING FOR A WINDSCREEN WIPER BLADE

(71) Applicant: VALEO SYSTEMES D'ESSUYAGE, La Verriere (FR)

(72) Inventors: Ipung PRASTOWO, Batam (ID); Thomas CAETANO, La Verriere (FR); Guillaume MOULEYRE, La Verriere (FR); Jocelyn VERET, La Verriere (FR)

(73) Assignee: VALEO SYSTEMES D'ESSUYAGE, La Verriere (FR)

(21) Appl. No.: 18/720,056

(22) PCT Filed: Dec. 14, 2022
(86) PCT No.: PCT/EP2022/085840

§ 371 Date: Jun. 14, 2024

(30) Foreign Application Priority Data
Dec. 17, 2021 (EP) 21215770.5

(51) Int. Cl. B65D 75/22; B65D 75/52; B65D 75/56

(52) U.S. Cl. CPC B65D 75/225; B65D 75/522; B65D 75/566; B65D 2575/565

(57) ABSTRACT

A packaging for a windscreen wiper blade, comprising a front face, a rear face, an assembly flap extending from one of said front and rear faces and configured to be permanently attached to the other of said front and rear faces, said front face and rear face being laminated to each other at at least one of a first longitudinal extremity and a second longitudinal extremity, forming a tab.

### TECHNICAL FIELD

The present invention concerns a packaging for a windscreen wiper blade, in particular a sleeve-type packaging. The present invention further concerns a method for fabricating such a packaging, as well as an ensemble comprising a windscreen wiper blade within such a packaging.

### BACKGROUND OF THE INVENTION

It is widely known to equip motor vehicles with at least one windscreen wiper, at the very least on the windscreen at the front of the vehicle, but in some cases also on the rear window. The structure of the windscreen wiper may vary, but in general comprises a soft rubber squeegee blade held in a frame which permits its mounting to a motorized wiper arm. When actuated, the windscreen wiper(s) are passed over the surface of the glass in a reciprocating motion, thereby sweeping any water, debris, etc. from the windscreen or rear window.

Consequently, the windscreen wiper blade is a wear part: the rubbing of the squeegee blade against the glass and any dust or grit thereon during operation, as well as degradation from environmental factors such as sunlight and ozone, will limit the lifespan of the rubber squeegee blade. Since the windscreen wiper is on the exterior of the vehicle, the vehicle owner is able to replace them without having any particular difficulty. Therefore, windscreen wiper blades are very commonly available for retail sale, not only at automotive-related outlets such as parts stores and service stations, but also at general retail outlets such as discount stores and department stores.

In such general retail outlets, in order to maximize shelf space windscreen wiper blades are conventionally packaged in a tubular sleeve, fabricated from a rugged plastic such as PET. These containers may then be hanged from pegs, in a vertical orientation.

However, this type of packaging presents several difficulties. First, the use of plastic to fabricate disposable packaging is more and more discouraged, in favor of renewable and less petroleum-dependent packaging materials such as cardboard. In addition to the evident environmentally-friendly aspects of using such materials, cardboard packaging has the additional advantage of ease of manufacture, in that they are generally cut or stamped from a single, flat sheet of stock and then folded and glued into the desired tubular shape.

However, cardboard containers have the disadvantage of being opaque, which tends to induce customers to open the package so that they may inspect the wiper blade prior to purchase. This increases the likelihood that the wiper blade is damaged and rendered unsaleable.

Moreover, cardboard windscreen wiper blade packaging known in the art are also disadvantageous, in that they are generally configured in a parallelepipedal (i.e. box-like) form. It is thus generally necessary to package the wiper blade itself in a separate, interior sleeve, to prevent the windscreen wiper blade from moving around within the packaging and damaging itself and/or the packaging. This requires further manipulation to assemble and increases the cost of the packaging.

Also, it is desirable generally to give the packaging an attractive visual aspect.

It is therefore an object of the present invention to provide an improved packaging for a windscreen wiper blade which remediates or resolves at least some of the problems described above.

### SUMMARY OF THE INVENTION

According, therefore, to a first aspect, the invention is directed towards a packaging for a windscreen wiper blade, comprising a front face, a rear face, an assembly flap extending from one of said front and rear faces and configured to be permanently attached to the other of said front and rear faces.

According to the invention, said front and rear faces are laminated to each other at at least one of a first longitudinal extremity and a second longitudinal extremity of the packaging, the lamination of the front and rear faces thereby forming a tab.

This is advantageous in that the packaging is easily fabricated from a single piece or sheet of packaging stock, and is provided with a great deal of strength and resilience with a minimum of manufacturing steps. Additionally, this is advantageous in that the resulting packaging will form a sleeve that is quickly and easily filled with a windscreen wiper blade in a production environment, which securely retains the windscreen wiper blade without damage to either the windscreen wiper blade or the packaging.

In one possible embodiment, the front and rear faces are laminated to each other at the first longitudinal extremity and at the second longitudinal extremity, the lamination of the front and rear faces thereby forming two tabs.

In another possible embodiment, the packaging further comprises at least one closure flap extending from at least one of the front and rear faces at the first longitudinal extremity thereof, the front and rear faces being laminated at the second longitudinal extremity opposite said at least one closure flap to form the tab.

Optionally, the packaging comprises two closure flaps, one of said closure flaps extending from the front face and the other of said closure flaps extending from the rear face.

Embodiments of the invention may also further include one or more of the following elements:

The at least one tab further comprises a hole or slot for a peg hook.

The at least one tab is aligned to a plane substantially parallel to the front and rear faces of the packaging.

The front and rear faces are laminated to each other by gluing, crimping, tacking, or stapling.

The assembly flap is attached to the other of the front and rear faces by gluing, crimping, tacking or stapling.

At least one of the front and rear faces comprises at least one crease line, said at least one crease line being configured to preferentially bend or fold along its length. Preferably, at least one of the front and rear faces comprises a plurality of longitudinal crease lines running along a longitudinal direction of the packaging, and at least one transverse crease line running along a transverse direction of the packaging and disposed proximate to at least one of the first and second longitudinal extremities.

The packaging is made from cardboard, cardstock, fiberboard, paper, or paperboard.

The front face is wider than the rear face in a transverse direction.

The packaging presents a generally polygonal cross-section. Preferably, the packaging presents a generally hexagonal cross-section.

At least one of the front face and rear face comprises a cutout forming a window. Preferably, the window is covered by a transparent or translucent material, for instance plastic, glassine, or wax paper.

According to a second aspect, the invention is directed towards an ensemble comprising a windscreen wiper blade and a packaging according to any or all of the foregoing possible embodiments.

### BRIEF DESCRIPTION OF THE DRAWINGS

These and other advantageous aspects, characteristics, and details of the present invention will be more readily understood when taken in light of the following description, and of the figures in which:

FIG. 1 is a plan view of a windscreen wiper blade packaging in flat, unfolded form, according to a first embodiment of the invention;

FIG. 2 is a detail view of the windscreen wiper blade packaging of FIG. 1, containing a windscreen wiper blade;

FIG. 3 is a cross-sectional view of the windscreen wiper blade packaging of FIG. 2;

FIG. 4 is a cross-sectional view of a windscreen wiper blade packaging according to a second embodiment of the invention;

FIG. 5 is a cross-sectional view of a windscreen wiper blade packaging according to a third embodiment of the invention;

FIG. 6 is a cross-sectional view of a windscreen wiper blade packaging according to a fourth embodiment of the invention; and

FIG. 7 is a plan view of a windscreen wiper blade packaging in a flat, unfolded form, according to a fifth embodiment of the invention.

### DETAILED DESCRIPTION OF THE INVENTION

It should first be noted that, in the above-referenced figures and in the following description, like numerals indicate like or corresponding parts throughout the several views. In addition, the following description references relative directions and orientations such as “TOP” and “FRONT”; it will be readily understood that these terms of orientation are used relative to a conventional arrangement of the product packaging, hanging on a store shelf or display in the manner well-known in the art of windscreen wiper blade packaging.

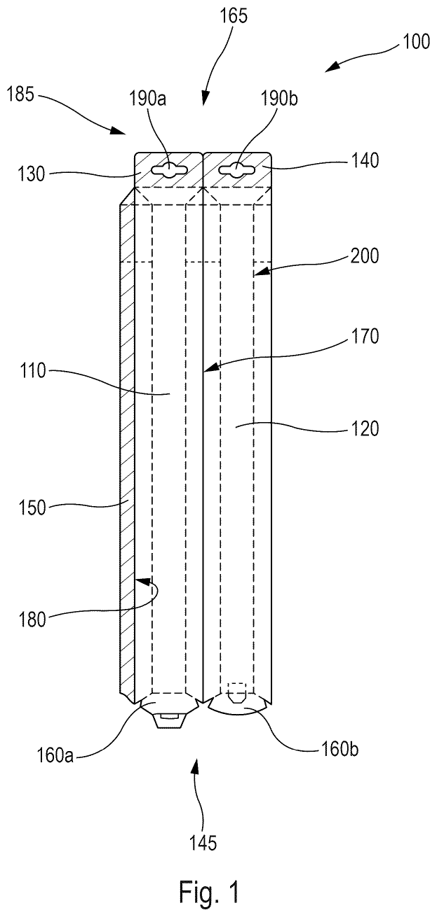

FIG. 1 illustrates a windscreen wiper blade packaging 100 according to the invention. More particularly, FIG. 1 illustrates the windscreen wiper blade packaging 100 in its flat state, after having been cut out from a sheet of a flat stock.

The stock is preferably a thin cardboard, as such material has advantageous attributes for physical strength, rigidity, durability, and economy. Alternatively, the stock may instead be a similar, fiber-based material such as cardstock, fiberboard, paper, paperboard, or the like, depending on the particular mechanical properties, water-resistance, etc. that may be required for any particular implementation.

The stock may be a single, homogeneous layer, or alternatively a multiple-layer stock may be implemented, comprising several layers having different compositions, material properties, grain orientation, etc. The stock may optionally be printed in one or several regions, for instance with labels, instructions, or the like. The stock may also optionally be given a coating, for instance a wax coating, so as to improve its physical properties such as water or abrasion resistance.

The windscreen wiper blade packaging 100 is generally comprised of several distinct parts, which together make up a contiguous whole. The windscreen wiper blade packaging 100 comprises a front face 110 and a rear face 120, which respectively constitute the front and rear portions of the windscreen wiper blade packaging 100.

The front and rear faces 110, 120 thus constitute the majority of the visible surface of the windscreen wiper blade packaging 100, and as such are generally printed with visual elements permitting the identification of its contents, such as product images, part numbers or references, barcodes, and the like. While not illustrated in the embodiment of FIG. 1, the front and/or rear faces 110, 120 may also be provided with cutouts and/or windows, so as to permit the product to be viewed directly by the customer.

The front and rear faces 110, 120 are elongated, defining a first longitudinal extremity 145 at the bottom of the windscreen wiper blade packaging 100, and a second longitudinal extremity 165 at the top of the windscreen wiper blade packaging 100.

Ideally, the front face is made slightly wider and/or longer than the rear face, so as to facilitate an assembly process described below. Alternatively, the front and rear faces may be made identical, so as to render the cross-sectional form of the packaging as symmetrical as possible.

The front and rear faces 110, 120 of the windscreen wiper blade packaging 100 further comprise tab portions 130, 140, proximal to a second longitudinal extremity 165. An assembly flap 150 extends from a longitudinal edge of the front face 110, and closure flaps 160a, 160b extend from the front and rear faces 110, 120 respectively, at a first longitudinal extremity 145 opposite the second longitudinal extremity 165.

In alternative embodiments, the assembly flap may be configured to extend from a longitudinal edge of the rear face 120. Alternatively, there may be provided a single closure flap, in lieu of the two closure flaps 160a, 160b illustrated in FIG. 1.

To assemble the windscreen wiper blade packaging 100, the front and rear faces 110, 120 are folded over each other, along folding line 170, and the assembly flap 150 is folded over the front face 110 along the folding line 180. The assembly flap 150 is subsequently glued to the rear face 120, thereby forming a continuous, tubular structure comprised of the front face 110, the rear face 120, and the assembly flap 150. In the exemplary embodiment illustrated in FIG. 1, the surface of the assembly flap 150 to which glue is applied is indicated with diagonal hatching.

Of course, other means for assembling the front face 110 to the rear face 120 may be envisioned, such as crimping, tacking, stapling, or sealing with e.g. paraffin wax.

Additionally, the act of folding the front and rear faces 110, 120 over each other will bring the two tab portions 130, 140 into contact; the tab portions 130, 140 are subsequently laminated to each other to form a single, laminated tab 185. In the exemplary embodiment illustrated in FIG. 1, the surface of the tab portions 130, 140 to which glue is applied is also indicated with diagonal hatching.

Alternatively, the tab portions 130, 140 may be laminated to each other by means other than gluing, for instance crimping, tacking, stapling, or sealing by e.g. paraffin wax.

The tab portions 130, 140 are also respectively provided with pegholes 190a, 190b, which may optimally be cut from the tab portions 130, 140 in the same operation in which the windscreen wiper blade packaging 100 is fabricated. Alternatively, a peghole may be cut from the tab portions 130, 140 once they are glued to each other and laminated into a single piece.

The pegholes 190a, 190b together permit the windscreen wiper blade packaging 100 to be hung from a conventional display peg, of the type frequently used in retail store product displays; the combination of the tab portions 130, 140 with the pegholes 190a, 190b thus creates a structure commonly known in the packaging and retail arts as a hang tab. This hang tab eliminates the need for the retailer to add its own, and reduces the likelihood that this added hang tab will be torn off or otherwise damaged by rough handling once the packaging is placed on for display and sale.

Of course, it will be understood that the exact form of the pegholes 190a, 190b may vary from the exemplary form illustrated in FIG. 1. Notably, they may comprise a slot or notch, rather than the hole employed in this exemplary embodiment.

Once the rear face 120 and the assembly flap 150 have been glued together, and the tab portions 130, 140 have been glued to each other to form the tab 185, the windscreen wiper blade packaging will be in a flat state. The next step is to insert the windscreen wiper blade (not illustrated) which the windscreen wiper blade packaging 100 is intended to contain. This may be easily accomplished by separating the front and rear faces 110, 120 at the second longitudinal extremity 165 and sliding the windscreen wiper blade into the windscreen wiper blade packaging 100.

In addition to the aforementioned folding lines 170, 180, the windscreen wiper blade packaging 100 is further provided with a plurality of crease lines 200. The crease lines 200 are indicated in FIG. 1 with dashed lines, although for the purposes of clarity only one of the crease lines 200 is numbered.

In FIG. 1, the crease lines 200 comprise several longitudinal crease lines, which run along a longitudinal direction of the packaging, from the first longitudinal extremity 145 to the second longitudinal extremity 165. Additional crease lines 200 run transversally, disposed proximal to the second longitudinal extremity 165, as well as diagonally near the second longitudinal extremity 165 as depicted in FIG. 1.

The crease lines 200 are lines formed in the windscreen wiper blade packaging 100 which preferentially deform when the windscreen wiper blade packaging 100 is deformed; in this manner, the final shape of the windscreen wiper blade packaging 100 is pre-defined. The crease lines 200 may be generated by a number of different processes, though in most embodiments it would be preferable to form them at the same moment or in the same process as cutting the windscreen wiper blade packaging 100 from the packaging stock; to this end, a stamping or embossing process may be preferable.

When the windscreen wiper blade (not depicted) is inserted into the windscreen wiper blade packaging 100 as mentioned above, the force of the windscreen wiper blade upon the front and rear faces 110, 120 will cause the windscreen wiper blade packaging 100 to deform; the crease lines 200 will cause it to assume a generally hexagonal cross-section. In addition, the elasticity of the windscreen wiper blade packaging 100 against the windscreen wiper blade will urge the front and rear faces 110, 120 against the windscreen wipe blade, retaining the windscreen wiper blade securely in place within the windscreen wiper blade packaging 100.

Once the windscreen wiper blade is inserted into the windscreen wiper blade packaging 100, one need only close the closure flaps 160a, 160b located at the first longitudinal extremity 145, which fold over each other and close the windscreen wiper blade packaging 100 in the conventional manner. The windscreen wiper blade packaging 100 may then be placed on display for sale.

Preferably, the windscreen wiper blade packaging 100 is suspended from a display peg inserted into the pegholes 190a, 109b in the tab 185; the first longitudinal extremity 145 is thus located at the bottom of the windscreen wiper blade packaging 100 and the second longitudinal extremity 165 is located at the top. Advantageously, any printing or labels applied to the front and rear faces 110, 120 are oriented to take this positioning into account. Alternatively, the windscreen wiper blade packaging 100 may be laid out flat for display, as on a shelf, or stocked in bins or pigeonholes; in any orientation, at least one printed face of the windscreen wiper blade packaging 100 will be visible to the consumer.

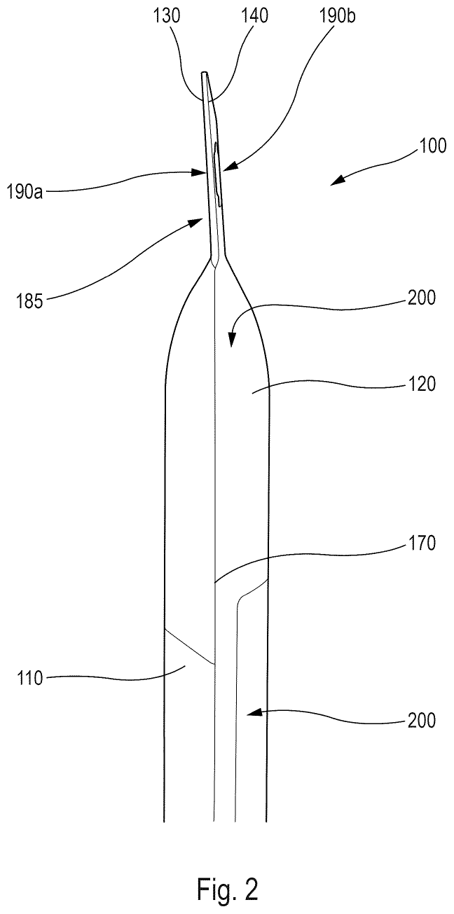

FIG. 2 is a detail view of the windscreen wiper blade packaging 100 in an assembled, filled state (i.e. containing a windscreen wiper blade). The front and rear faces 110, 120 are clearly visible, as is the folding line 170 and some of the crease lines 200. Additionally, it is clearly seen that the two tab portions 130, 140 are laminated together to form a tab 185, providing a rigid, durable support for the pegholes 190a, 190b.

Additionally, it can be seen from FIG. 2 that the tab 185, comprised of the two laminated tab portions 130, 140, is disposed in a plane substantially parallel to, and equidistant from, each of the front and rear faces 110, 120, albeit with the latter being subject to a certain degree of deformation the windscreen wiper blade contained within the windscreen wiper blade packaging 100.

In fact, the windscreen wiper blade packaging 100, when a windscreen wiper blade is disposed within, will assume a form having a generally hexagonal cross-section; this is particularly advantageous in that not only is the windscreen wiper blade retained securely therein, without need for additional packaging elements such as sleeves or clips, but also in that the hexagonal cross-section of the windscreen wiper blade package 100 permits it to be stacked and boxed in quantity in a manner which minimizes wasted space within a shipping box or container. In this manner, the windscreen wiper blade packaging 100 is rendered even more efficient and ecological, in that a given consignment of wiper blades will take up less space and require fewer trucks, shipping containers, etc. to transport it.

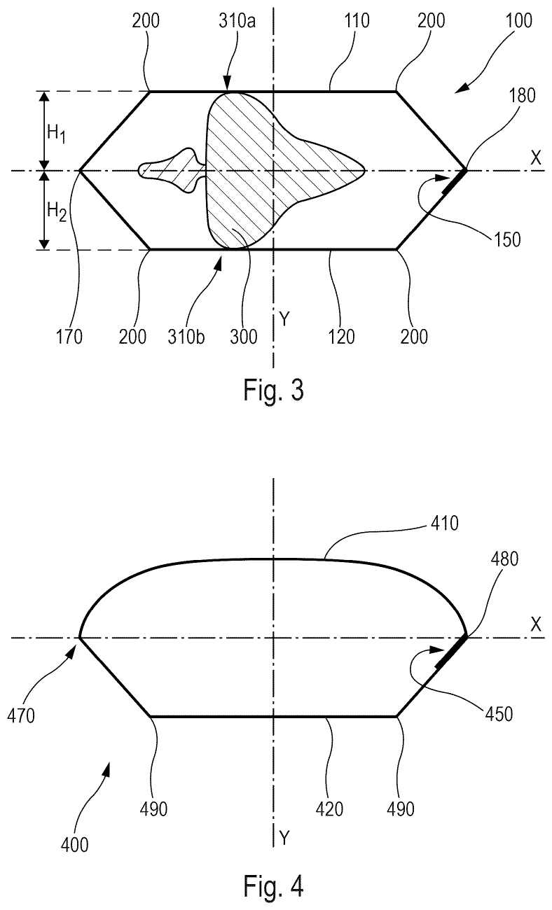

FIG. 3 illustrates the generally hexagonal form of the windscreen wiper blade packaging 100. Specifically, FIG. 3 is a cross-sectional view of the windscreen wiper blade packaging 100 at an intermediate point thereof, i.e. not including a tab at one or both extremities, nor the tapering portion of the windscreen wiper blade packaging 100 proximate to the tab, nor any closure flaps at another extremity.

It is particularly seen that the front face 110 and the rear face 120 of the windscreen wiper blade packaging 100 are connected, at the left side of the figure at the folding line 170, and at the right side of the figure by the folding line 180 and the assembly flap 150. The assembly flap 150 is laminated to the edge of the lower face 120, for instance by gluing, as described above.

In the embodiment depicted in FIG. 3, the cross-section of the windscreen wiper blade packaging 100 is laterally symmetric across both the transverse axis x and the vertical axis y. In particular, the front face 110 and the rear face 120 are fabricated with the same width, i.e when the windscreen wiper blade packaging 100 is in the flat, pre-folded configuration illustrated in FIG. 1, the widths of these two elements are equal. Consequently, when the windscreen wiper blade packaging 100 is assembled and filled, as in FIGS. 2 and 3, the heights H1 and H2 (in other terms, the height H1 above the transverse axis x and the height H2 below the transverse axis x) are equal.

In this way, the windscreen wiper blade packaging is provided with a uniform, symmetrical shape, making it easier to pack, transport, and stack en masse, as noted above.

Additionally, in FIG. 3 a schematic representation of a windscreen wiper blade 300 is illustrated. As noted above, the windscreen wiper blade packaging 100 is provided with a degree of elasticity, due to the rigidity of the material (e.g. cardboard) from which it is fabricated, combined with the provision folding lines 170, 180. This natural elasticity causes the windscreen wiper blade packaging 100, once the windscreen wiper blade 300 is disposed within, to tend to try to revert to its original, flat configuration.

This tendency will cause at least the front and rear faces 110, 120 to close around the windscreen wiper blade 300, retaining it in place. In the embodiment illustrated in FIG. 3, the front face 110 and rear face 120 contact the windscreen wiper blade 300 at the contact points 310A, 310B respectively.

However, it will be understood that the location and quantity of the contact points of the windscreen wiper blade packaging may vary according to the shape thereof, and the location on the windscreen wiper blade in question, as well as upon the form and dimensions of the windscreen wiper blade packaging.

Moreover, while in the embodiment of FIGS. 1-3 the windscreen wiper blade packaging 100 has a generally hexagonal cross-section, in other embodiments of the invention different polygonal shapes may be envisaged for the cross-section of the windscreen wiper blade packaging, for instance pentagons or octagons, according to the practical and aesthetic constraints of the particular application in question.

Several variant embodiments of a windscreen wiper blade packaging according to the invention will now be discussed with reference to FIGS. 4 to 6; such discussion should be considered as non-exhaustive, and merely an exposition of possible variants that nonetheless fall within the scope of the present invention. Moreover, while a windscreen wiper blade is omitted from FIGS. 4 to 6, it will be readily understood that the windscreen wiper blade packagings depicted therein are adapted to contain such a windscreen wiper blade therein in the manner described above with reference to FIG. 3.

FIG. 4 illustrates a section view of a windscreen wiper blade packaging 400 according to a second embodiment of the invention. As in the embodiment described in relation to FIGS. 1 to 3, the windscreen wiper blade packaging 400 is fabricated from a single sheet of material, and comprises a front face 410, a rear face 420, and an assembly flap 450. The front face 410 meets the rear face 420 at the folding line 470, and the assembly flap 450 at the folding line 480. The assembly flap 450 is attached to the inside surface of the rear face 420, by e.g. gluing.

The windscreen wiper blade packaging 400 is distinguished from the windscreen wiper blade packaging 100 by virtue of the fact that only the rear face 420 is provided with crease lines 490. The front face 410 is instead allowed to freely assume a curved form. The curved form illustrated in FIG. 4 is only an example; the form of the front face may vary according to the shape and size of the windscreen wiper blade within the windscreen wiper blade packaging 400, as well as the specific location on the windscreen wiper blade packaging 400 in question.

Alternatively, the rear face may present a curved form, and the front face may be provided with crease lines, in an inverse configuration of FIG. 4.

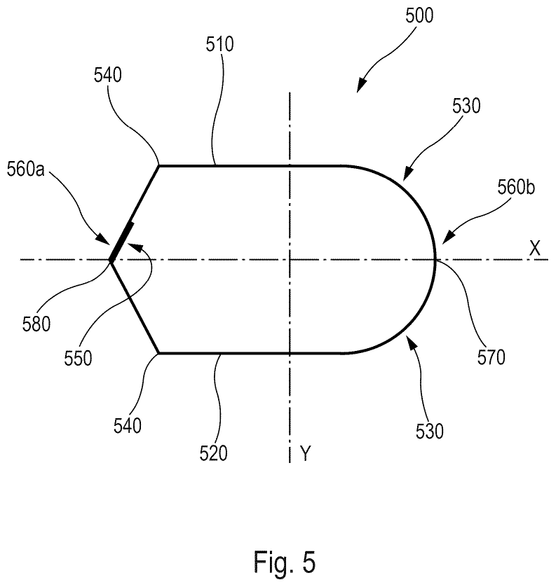

FIG. 5 presents still another alternative embodiment of a windscreen wiper blade packaging 500. The windscreen wiper blade packaging 500 of FIG. 5 is distinguished in that both the front face 510 and the rear face 520 present a curved portion 530 and a crease line 540.

Thus, a first lateral edge 560A of the windscreen wiper blade packaging 500 (as illustrated in the section view here) presents a generally prismatic aspect, being the side provided with the crease lines 540; while the second lateral edge 560B presents a more natural, curvilinear aspect.

Additionally, it will be noted that the assembly flap 550 in the embodiment of FIG. 5 extends, not from the front face 510 as in the embodiments of FIGS. 1 to 4, but from the rear face 520. Such a configuration may be preferable in

Of course, it will be understood that this configuration is given in FIG. 5 solely for illustrative purposes, and is not limited to the embodiment of FIG. 5. Indeed, any of the other embodiments presented in this application may be provided with the assembly flap extending from the opposite of the front or rear face as depicted above, without substantially affecting the shape or performance of the windscreen wiper blade packaging.

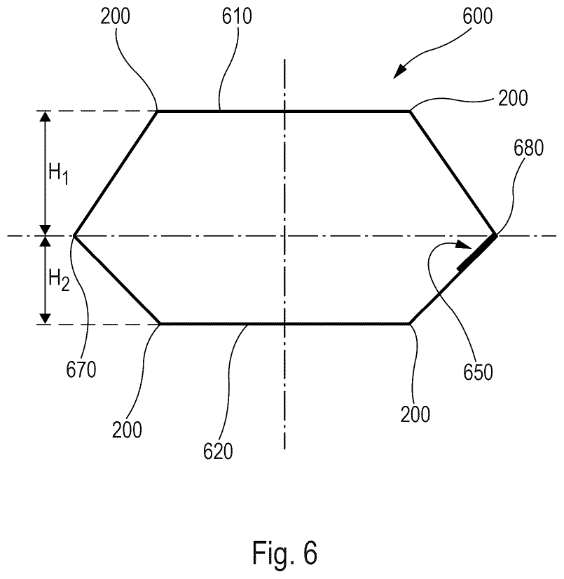

FIG. 6 illustrates a section view of a windscreen wiper blade packaging 600, according to still another embodiment of the invention. The windscreen wiper blade packaging 600 of FIG. 6 is substantially similar to the windscreen wiper blade packagings described in reference to FIGS. 1 to 5, in that it comprises a front face 610, a rear face 620 linked to the front face on one side by a folding line 170 and on another side by an assembly flap 650 extending from a folding line 680, the assembly flap being attached to the rear face 620. The windscreen wiper blade packaging 600 is provided with a plurality of crease lines 200, which cause the windscreen wiper blade packaging 600 to assume a generally polygonal cross-section once assembled.

However, in the windscreen wiper blade packaging 600, the front face 610 is wider than the rear face 620, such that once the windscreen wiper blade packaging 600 is fully assembled, the height H1 (i.e. the protrusion of the front face 310 in the positive y-axis) is greater than the height H2 (i.e. the protrusion of the rear face 320 in the negative y-axis).

Such a configuration may be advantageous for certain forms of the windscreen wiper to be contained therein, and/or for aesthetic configurations.

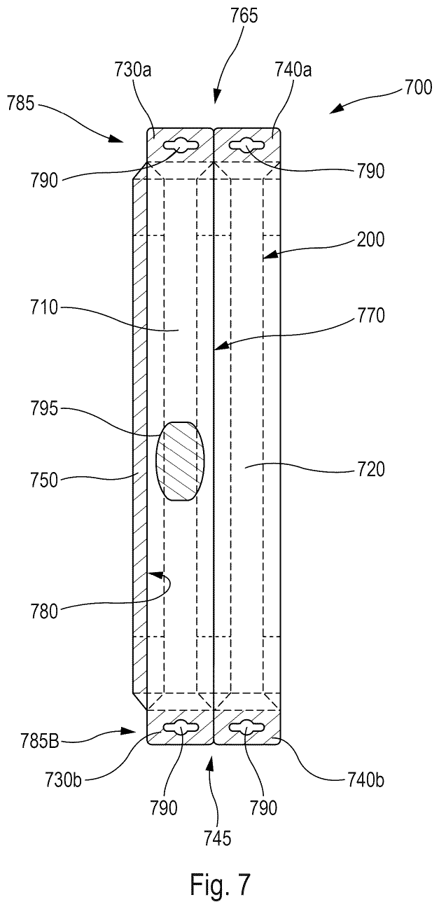

FIG. 7 illustrates another possible embodiment of the present invention. More particularly, FIG. 7 illustrates the windscreen wiper blade packaging 100 in its flat state, after having been cut out from a sheet of a flat stock, in the same way as described above with respect to the embodiment of FIGS. 1 to 3.

Likewise, as in the embodiment of FIG. 1, the embodiment illustrated in FIG. 7 presents a front face 710, a rear face 720, and an assembly flap 750. Crease lines 200 are provided on the front and rear faces 710, 720, in the same manner as described above.

The embodiment depicted in FIG. 7 differs from the embodiment described above, in that it is provided tabs 785A, 785B at both its first and second longitudinal extremities 145, 165, respectively. More particularly, the first extremity 745 is provided with a tab portion 730B prolonging the first face 710 and a tab portion 740B prolonging the second face 720, and likewise the second extremity 765 is provided with a tab portion 730A prolonging the first face 710 and a tab portion 740A prolonging the second face 720.

Once the second face 720 is folded over the first face 710 and the assembly flap 750 is attached to the first face, a windscreen wiper blade (not depicted) can be inserted into the windscreen wiper blade packaging 700. The tab portions 730B and 740B are then laminated to each other, in the manner described above, to seal the first longitudinal extremity 745 and form a tab 785B. Likewise, the tab portions 730A and 740A are laminated to each other to seal the second longitudinal extremity 765 and form a tab 785A.

In the embodiment depicted in FIG. 7 both of the tabs 785A, 785B are provided with pegholes 790. However, in other implementations the windscreen wiper blade packaging 700 may be configured such that only one of the tabs 785A, 785B, or neither of them, is provided with a peghole.

Additionally, FIG. 7 depicts another possible variation to the windscreen wiper blade packaging, in the form of the window 795. The window 795 is fabricated by cutting or punching out a region of the windscreen wiper blade packaging 700, generally prior to assembly; in FIG. 7 the window 795 is present only on the front face 710, but in other embodiments may be positioned on the rear face only instead, on both faces so as to form two discrete windows, or as one cutout extending across both faces so as to wrap around the folding line for a different aesthetic effect. The size and shape of the window 795 illustrated in FIG. 7 is merely exemplary, and indeed both can be varied according to the needs of the application in question.

The presence of the window 795 permits the user to view and inspect the windscreen wiper blade prior to purchase without having to open the windscreen wiper blade packaging 700 or remove the windscreen wiper blade from it.

The window 795 may be configured as a simple cut-out, in which case the windscreen wiper blade within the windscreen wiper blade packaging 700 will be exposed to the outside atmosphere; such a configuration is simple and economical to implement, and maximizes the recyclability of the windscreen wipe blade packaging 700 once it has been opened and the windscreen wiper blade removed.

Alternatively, it may be preferable to attach a small piece of a transparent or translucent material to the interior surface of the windscreen wiper blade packaging 700, so as to cover the window 795. The transparent or translucent piece may be made from materials known in the packaging art, in particular a thin transparent plastic (e.g. cellophane, polyethylene, or polypropylene), or alternatively a translucent paper-based substance such as glassine or wax paper. So configured, the windscreen wiper blade packaging 700 retains a high degree of resistance to the ingress of water, dust, or other contamination.

In either case, such a windscreen wiper blade packaging is particularly interesting when taken in consideration of the windscreen wiper blade packagings known in the art, wherein in order to permit the user to visually inspect the windscreen wiper blade prior to purchase, the entire packaging is fabricated from a transparent plastic material. The windscreen wiper blade packaging of the present invention presents a solution which is at once more economical and more ecological than those known in the art.

It will be well understood that the skilled person can conceive of many variations and adaptations of the windscreen wiper blade packaging described above, combining aspects of one or more of the embodiments described in the foregoing, without departing from the scope of the invention as claimed. Accordingly, the foregoing description should be considered as exemplary and non-limiting.

### LIST OF REFERENCE SIGNS

| | |
|---|---|
| Windscreen wiper blade packaging | 100, 400, 500, 600, 700 |
| Front face | 110, 410, 510, 610, 710 |
| Rear face | 120, 420, 520, 620, 720 |
| Tab portions | 130, 140, 730A, 730B, 740A, 740B |
| First longitudinal extremity | 145, 745 |
| Assembly flap | 150, 450, 550, 650, 750 |
| Closure flaps | 160A, 160B |
| Second longitudinal extremity | 165, 765 |
| Folding lines | 170, 180, 470, 480, 570, 580, |
| | 670, 680, 770, 780 |
| Tab | 185, 785A, 785B |
| Peg hole | 190a, 190b, 790 |
| Crease line | 200, 490, 540 |
| Windscreen wiper blade | 300 |
| Contact point | 310A, 310B |
| Curved portion | 530 |
| First lateral edge | 560A |
| Second lateral edge | 560B |
| Window | 795 |

What is claimed is:

1. A packaging for a windscreen wiper blade, comprising a front face, a rear face, an assembly flap extending from one of said front and rear faces and configured to be permanently attached to the other of said front and rear faces,
characterized in that said front face and rear face are laminated to each other at least one of a first longitudinal extremity and a second longitudinal extremity of the packaging, the lamination of the front and rear faces thereby forming a tab.

2. The packaging according to claim 1, wherein the front face and rear faces are laminated to each other at the first longitudinal extremity and at the second longitudinal extremity, the lamination of the front and rear faces thereby forming two tabs.

3. The packaging according to claim 1, further comprising at least one closure flap extending from at least one of the front and rear faces at the first longitudinal extremity thereof, the front and rear faces being laminated at the second longitudinal extremity opposite said at least one closure flap to form the tab.

4. The packaging according to claim 3, wherein the packaging comprises two closure flaps, one of said closure flaps extending from the front face and the other of said closure flaps extending from the rear face.

5. The packaging according to claim 1, wherein the at least one tab further comprises a hole or slot for a peg hook.

6. The packaging according to claim 1, wherein the at least one tab is aligned to a plane substantially parallel to the front and rear faces of the packaging.

7. The packaging according to claim 1, wherein the front and rear faces are laminated to each other by gluing, crimping, tacking, or stapling.

8. The packaging according to claim 1, wherein at least one of the front and rear faces comprises at least one crease line, said at least one crease line being configured to preferentially bend or fold along its length.

9. The packaging according to claim 8, wherein at least one of the front and rear faces comprises at least two longitudinal crease lines running along a longitudinal direction of the packaging, and at least one transverse crease line running along a transverse direction of the packaging and disposed proximal to at least one of the first and second longitudinal extremities.

10. The packaging according to claim 1, wherein the packaging is made from cardboard, cardstock, fiberboard, paper, or paperboard.

11. The packaging according to claim 1, wherein the front face is wider than the rear face in a transverse direction.

12. The packaging according to claim 1, wherein the packaging presents a generally polygonal cross-section.

13. The packaging according to claim 12, wherein the packaging presents a generally hexagonal cross-section.

14. The packaging according to claim 1, wherein at least one of the front face and rear face comprises a cutout forming a window.

15. An ensemble comprising a windscreen wiper blade and a packaging according to claim 1.
